(19) United States
(12) Patent Application Publication
(10) Pub. No.: US 2025/0055907 A1
(43) Pub. Date: Feb. 13, 2025

(54) CROSS-ECOLOGICAL DEVICE MANAGEMENT AND CONTROL METHOD AND APPARATUS, AND STORAGE MEDIUM AND ELECTRONIC DEVICE

(71) Applicant: SHENZHEN TCL NEW TECHNOLOGY CO., LTD., Shenzhen, Guangdong (CN)

(72) Inventor: Hui LI, Shenzhen, Guangdong (CN)

(73) Assignee: SHENZHEN TCL NEW TECHNOLOGY CO., LTD., Shenzhen, Guangdong (CN)

(21) Appl. No.: 18/723,341

(22) PCT Filed: Oct. 11, 2022
(86) PCT No.: PCT/CN2022/124502

§ 371 Date: Jun. 21, 2024

(30) Foreign Application Priority Data
Dec. 23, 2021 (CN) 202111590641.3

(51) Int. Cl. H04L 67/1087; H04L 9/40

(52) U.S. Cl. CPC H04L 67/1087; H04L 63/102

(57) ABSTRACT

The present application relates to the technical field of the Internet of Things. Disclosed are a cross-ecological device management and control method and apparatus, and a storage medium and an electronic device. The method comprises: generating cross-ecological sharing information of a device to be subjected to sharing; and transmitting, in a cross-application manner, the cross-ecological sharing information to an application to be shared, wherein said application and said device belong to a different ecology, and said application accesses a target cloud end on the basis of the cross-ecological sharing information and without negotiation, so as to perform cross-ecological management and control on said device. The present application realizes convenient and effective cross-ecological device management and control.

### TECHNICAL FIELD

The application relates to the field of the Internet of Things technology, and specifically to a cross-ecosystem device management and control method, device, storage medium and electronic device.

### BACKGROUND

Cross-ecosystem device management and control is the task of one of the devices of two different ecosystems (such as manufacturers) controlling the other. Currently, cross-ecosystem device management and control is usually achieved by the clouds of two ecosystems through prior negotiation and interoperability, and this cloud-cloud interconnection is a point-to-point access solution, and the two parties must first reach a business cooperation before they can achieve cross-ecosystem network interconnection.

### SUMMARY

### Technical Problems

Under the current method, information islands and small networks are inevitably generated, and it is usually difficult for users to sort out the relationship between these islands and small networks. Cross-ecosystem networking is difficult, resulting in difficulty in cross-ecosystem device management and control.

### Solution to Technical Problem

### Technical Solution

The embodiment of the application provides a solution that can conveniently and effectively perform a cross-ecosystem device management and control.

The embodiment of the present disclosure provides the following technical scheme:

According to an embodiment of the present disclosure, a cross-ecosystem device management and control method comprises: generating cross-ecosystem sharing information of the device to be shared based on a target application, wherein the device to be shared belongs to a target ecosystem; transmitting the cross-ecosystem sharing information across applications to the application to be shared, wherein the application to be shared and the device to be shared belong to different ecosystems. The application to be shared accesses a target cloud of the target ecosystem without negotiation based on the cross-ecosystem sharing information, so as to perform a cross-ecosystem management and control on the device to be shared through the target cloud.

In some embodiments of the present disclosure, prior to the transmitting of the cross-ecosystem sharing information across applications to the application to be shared, the method further comprises: displaying an authorization prompt content for information sharing through the target application; and receiving response information of the authorization prompt content to determine whether to transmit the cross-ecosystem sharing information across applications based on the response information.

In some embodiments of the present disclosure, the cross-ecosystem sharing information comprises basic address information of the target cloud, device information of the device to be shared and access credentials; the step that the application to be shared accesses the target cloud of the target ecosystem without negotiation based on the cross-ecosystem sharing information so as to perform the cross-ecosystem management and control on the device to be shared through the target cloud comprising: obtaining, by the application to be shared, an TSL model and pre-agreed path information, and constructing an access address according to the path information and the basic address information, and constructing access parameters according to a pre-agreed format based on the device information, the access credentials and the TSL model, and based on the access address and the access parameters, sending a target instruction to the target cloud, so that the target cloud manages and controls the device to be shared.

In some embodiments of the present disclosure, the cross-ecosystem sharing information comprises basic address information of the target cloud, device information of the device to be shared and access credentials; the step that the application to be shared accesses the target cloud of the target ecosystem without negotiation based on the cross-ecosystem sharing information so as to perform the cross-ecosystem management and control on the device to be shared through the target cloud comprising: the application to be shared transmitting the cross-ecosystem sharing information to the belonging cloud of the ecosystem to which the application to be shared belongs, wherein the belonging cloud obtains the TSL model and the pre-agreed path information, constructs an access address according to the path information and the basic address information, and constructs access parameters according to a pre-agreed format based on the device information, the access credentials and the TSL model, and the belonging cloud sends a target instruction to the target cloud based on the access address and the access parameters, so that the target cloud manages and controls the device to be shared.

In some embodiments of the present disclosure, the step of transmitting the cross-ecosystem sharing information across applications to the application to be shared comprises: displaying an application list based on the target application; determining the application to be shared selected from the application list; and transmitting the cross-ecosystem sharing information to the application to be shared using a cross-application protocol through the target application.

In some embodiments of the present disclosure, the step of transmitting the cross-ecosystem sharing information across applications to the application to be shared comprises: obtaining an information transmission content containing the cross-ecosystem sharing information based on the target application; and sending the information transmission content to a target terminal through the target application, so that the target terminal opens the application to be shared based on a target protocol and transmits the information transmission content to the application to be shared.

In some embodiments of the present disclosure, the step of transmitting the cross-ecosystem sharing information across applications to the application to be shared comprises: obtaining an information transmission content containing the cross-ecosystem sharing information based on the target application, and copying the information transmission content to a target location so that the application to be shared obtains the information transmission content from the target position when a target object opens the application to be shared.

In some embodiments of the present disclosure, a cross-ecosystem device management and control device includes a generation module and a sharing module. The generation module is used to generate cross-ecosystem sharing information of the device to be shared based on a target application, and the device to be shared belongs to a target ecosystem. The sharing module is used to transmit the cross-ecosystem sharing information across applications to the application to be shared, wherein the application to be shared and the device to be shared belong to different ecosystems. The application to be shared accesses the target cloud of the target ecosystem without negotiation based on the cross-ecosystem sharing information, so as to perform a cross-ecosystem management and control on the device to be shared through the target cloud.

According to another embodiment of the present disclosure, a storage medium storing computer program is provided. When the computer program is executed by a processor of a computer, the computer may perform the method described in the embodiments of the present disclosure.

According to another embodiment of the present disclosure, an electronic device may comprise: a memory storing a computer program; and a processor reading the computer program stored in the memory to perform the methods described in the embodiments of the present disclosure.

### Beneficial Effect of the Present Disclosure

### Advantageous Effect

In the embodiment of the present disclosure, the cross-ecosystem sharing information of the device to be shared is generated based on the target application, wherein the device to be shared belongs to the target ecosystem; the cross-ecosystem sharing information is transmitted across applications to the application to be shared, wherein the application to be shared and the device to be shared belong to different ecosystems, wherein the application to be shared accesses the target cloud of the target ecosystem without negotiation based on the cross-ecosystem sharing information, so as to perform the cross-ecosystem management and control on the device to be shared through the target cloud.

In this way, the cross-ecosystem sharing information can be transmitted across applications to the application to be shared, and the application to be shared can access the target cloud of the target cloud based on the cross-ecosystem sharing information without negotiation, and the cross-ecosystem management and control can be performed on the device to be shared through the target cloud, thus achieving convenient and effective cross-ecosystem device management and control.

### BRIEF DESCRIPTION OF DRAWINGS

### Description of the Drawings

In order to more clearly illustrate the technical solutions in the embodiments of the present application, the drawings required to be used in the description of the embodiments will be briefly introduced below, and it is obvious that the drawings described below are only some embodiments of the present application, and for those skilled in the art, other drawings can be obtained according to these drawings without creative labor.

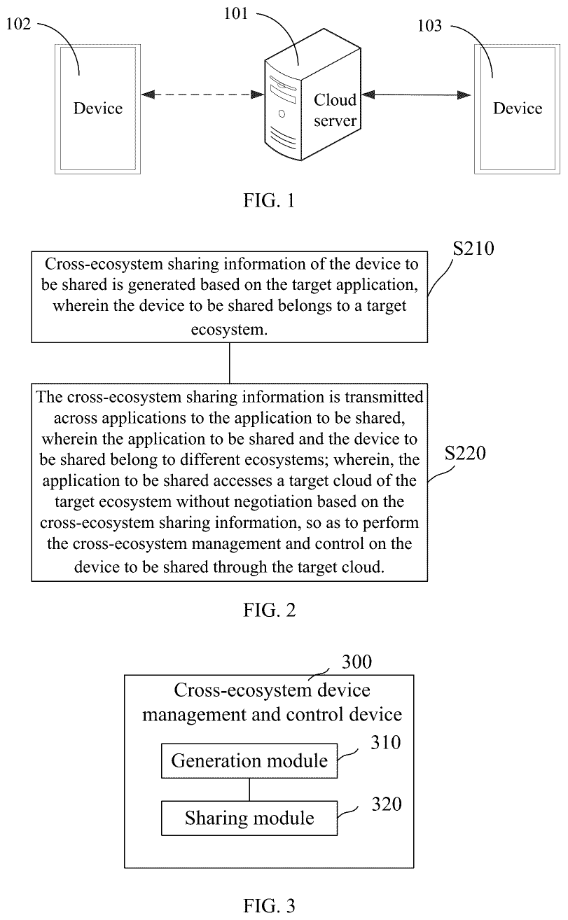

FIG. 1 is a schematic diagram of a system according to an embodiment of the present disclosure

FIG. 2 is a flowchart illustrating a cross-ecosystem device management and control method according to an embodiment of the present disclosure.

FIG. 3 is a block diagram illustrating a cross-ecosystem device management and control device according to an embodiment of the present disclosure.

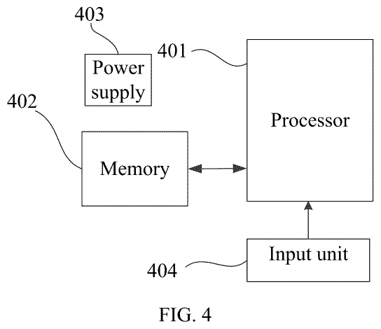

FIG. 4 is a block diagram illustrating an electronic device according to an embodiment of the present disclosure.

### EMBODIMENT OF THE PRESENT DISCLOSURE

### Detailed Description of the Present Disclosure

The technical solutions in the embodiments of the present disclosure will be clearly and completely described below in conjunction with the accompanying drawings in the embodiments of the present disclosure, and it is obvious that the described embodiments are only part of the embodiments of the present disclosure, not all embodiments. Based on the embodiments in the present disclosure, all other embodiments obtained by a person skilled in the art without creative work fall within the scope of protection of the present disclosure.

In the following description, the specific embodiments of the present disclosure will be illustrated with reference to the steps and symbols performed by one or more computers, unless otherwise stated. Thus, these steps and operations will be referred to several times as being performed by a computer, and the computer execution referred to in this article includes operations performed by a computer processing unit that represents an electronic signal of data in a structured form. This operation converts the data or maintains it at a location in the computer's memory system, which may be reconfigured or otherwise altered in a manner familiar to those skilled in the art. The data structure maintained by the data is the physical location of the memory, which has specific characteristics defined by the data format. However, the principle of the present disclosure is illustrated in the above wording, which does not represent a limitation, and a person skilled in the art will be able to understand that the following various steps and operations can also be implemented in hardware.

FIG. 1 illustrates a schematic diagram of a system 100 according to an embodiment of the present disclosure. As shown in FIG. 1, the system 100 may comprise a cloud server 101, a device 102 and a device 103. The device 102 and device 103 can be any computer device, such as a computer, a mobile phone, a smart watch, a home appliance and so on. The cloud server 101 can be a server that provides cloud services.

In one embodiment of this example, the device 102 may: generate cross-ecosystem sharing information of the device to be shared based on a target application, wherein the device to be shared belongs to a target ecosystem; transmit the cross-ecosystem sharing information across applications to the application to be shared, wherein the application to be shared and the device to be shared belong to different ecosystems, wherein the application to be shared accesses a target cloud of the target ecosystem (such as the cloud server 101) without negotiation based on the cross-ecosystem sharing information, so as to perform a cross-ecosystem management and control on the device to be shared (such as the device 103) through the target cloud.

FIG. 2 schematically illustrates a flow chart of a cross-ecosystem device management and control method according to an embodiment of the present disclosure. The cross-ecosystem device management and control method can be performed by any device, such as the device 102 as shown in FIG. 1.

As shown in FIG. 2, the cross-ecosystem device management and control method can include steps S210 to S220.

In step S210, cross-ecosystem sharing information of the device to be shared is generated based on the target application, wherein the device to be shared belongs to a target ecosystem.

In step S220, the cross-ecosystem sharing information is transmitted across applications to the application to be shared, wherein the application to be shared and the device to be shared belong to different ecosystems; wherein, the application to be shared accesses a target cloud of the target ecosystem without negotiation based on the cross-ecosystem sharing information, so as to perform the cross-ecosystem management and control on the device to be shared through the target cloud.

The device to be shared belongs to a target ecosystem, such as a target manufacturer or a custom divided device ecosystem, or the like. The cross-ecosystem sharing information refers to information that uses by devices in other ecosystems to directly access the cloud of the target ecosystem to management and control the devices to be shared. The target application and the device to be shared can belong to the same target ecosystem, and after the user selects the device to be shared in the target application, the target application can generate the corresponding cross-ecosystem sharing information.

After the cross-ecosystem sharing information is generated in the target application, it is transmitted to the application to be shared through cross-application means in which the application to be shared and the device to be shared belong to different ecosystems, and the application to be shared can access the target cloud of the target ecosystem corresponding to the device to be shared based on the cross-ecosystem sharing information without negotiation, and then the application to be shared can perform the cross-ecosystem management and control on the device to be shared through the target cloud.

In this way, based on steps S210 to S220, the cross-ecosystem sharing information is transmitted across applications to the application to be shared, and the application to be shared accesses the target cloud of the target ecosystem based on the cross-ecosystem sharing information without negotiation, and the cross-ecosystem management and control of the device to be shared can be performed through the target cloud, so as to achieve convenient and effective cross-ecosystem device management and control.

The following describes the specific process of each step when performing the cross-ecosystem device management and control.

In step S210, the cross-ecosystem sharing information of the device to be shared is generated based on the target application, wherein the device to be shared belongs to a target ecosystem.

The device to be shared belongs to a target ecosystem, such as a target manufacturer or a custom divided device ecosystem, or the like. The cross-ecosystem sharing information refers to information that uses by devices in other ecosystems to directly access the cloud of the target ecosystem to management and control the devices to be shared. The target application and the device to be shared can belong to the same target ecosystem, and after the user selects the device to be shared in the target application, the target application can generate the corresponding cross-ecosystem sharing information.

The cross-ecosystem sharing information may include basic address information of the cloud of the target ecosystem (such as the basic URL of the cloud of manufacturer A), device information of the device to be shared (such as the unique ID list of the device to be shared, each device to be shared corresponding to an ID), and access credentials (including refresh credential Tokens and access credential Tokens), etc.

In one embodiment, before the cross-ecosystem sharing information is transmitted across applications to the application to be shared in the step S210, the method further comprises: displaying an authorization prompt content for information sharing through the target application; receiving response information for the authorization prompt content, and determining whether to transmit the cross-ecosystem sharing information across applications based on the response information.

The authorization prompt content is content that is displayed in the target application to prompt the user for authorization. For example, the target application may display the authorization prompt content “This information is very important, please don't transmit it easily”, in which the transmission is roughly equivalent to granting device information and control rights, etc., and requires the user's consent. When the user clicks on an authorization response control such as agreed or disagreed in the display interface, response information may be generated, and then it may be determined whether or not to transmit the cross-ecosystem sharing information across applications based on the response information. For example, if the response information is agreed, it is determined that the cross-ecosystem sharing information is transmitted across the applications, and on the contrary, if the response information is disagreed, it is determined that the cross-ecosystem sharing information may not be transmitted across the applications. This can further improve the reliability of cross-ecosystem device management and control.

In one embodiment, in the step S210, the step of transmitting the cross-ecosystem sharing information across applications to the application to be shared may comprise: displaying an application list based on the target application; determining the application to be shared selected from the application list; and transmitting the cross-ecosystem sharing information to the application to be shared using cross-application protocols through the target application.

An application list may be displayed in the target application, wherein at least one application may be displayed in the application list. A user may select the application to be shared from the application list, and then the target application may transmit the cross-ecosystem sharing information to the application to be shared through a preset cross-application protocol between the target application and the to-be-shared application, wherein the cross-application protocol is the protocol for message transmission between the two types of applications, and the message in the target application can be converted into a message acceptable to the application to be shared through the cross-application protocol.

In one example, the application list may list all applications in the system that meet the same criterion for selection by the user, and the optional ways to list all applications include: applications that declare the same URL scheme, such as “Operational Level Agreement (OLA)”, where the URL scheme is a mechanism provided by the system, which can be registered by an application, and then called by other applications through the url scheme; and/or, applications that declare they can open the same type of file, such as those declared “application/ola.device.sharepayload”, and/or, applications that declare a sharing control that contains a same keyword, e.g., those declared “ola.tcl.shareplayload”.

Furthermore, in one example, the target application and the application to be shared are on the same device, and the device can automatically jump to the application to be shared through the user operation after the user transmits the cross-ecosystem sharing information to the application to be shared using the cross-application protocol through the target application.

In one embodiment, in the step S210, the step of transmitting the cross-ecosystem sharing information across applications to the application to be shared may comprise: obtaining an information transmission content containing the cross-ecosystem sharing information based on the target application; sending the information transmission content to a target terminal through the target application such that the target terminal opens the application to be shared according to a target protocol and transmits the information transmission content to the application to be shared.

The target application may display an information transmission content that contains the cross-ecosystem sharing information, such as a QR codes, a URL, a string, and other information transmission content. The target application may send the information transmission content to the target terminal via email, instant messaging software, wireless transmission protocols (e.g., Bluetooth, AirDrop, etc.) and so on.

After receiving the information transmission content, the target terminal may open the application to be shared that declares the target protocol corresponding to the information transmission content, and pass this information transmission content, such as a QR code, a URL, or a string, to the application to be shared.

In one embodiment, in the step S210, the step of transmitting the cross-ecosystem sharing information across applications to the application to be shared may comprise: obtaining an information transmission content containing the cross-ecosystem sharing information based on the target application, and copying the information transmission content to a target location so that the application to be shared may obtain the information transmission content from the target location when a target object opens the application to be shared.

The target location, such as a clipboard or a specific storage location, etc., and after the target application copies the information transmission content to the target location, the application to be shared can automatically obtain or manually obtain by the user the information transmission content from the target location after it has been opened.

In step S220, the cross-ecosystem sharing information is transmitted across applications to the application to be shared, and the application to be shared and the device to be shared belong to different ecosystems; wherein, the application to be shared accesses a target cloud of the target ecosystem without negotiation based on the cross-ecosystem sharing information, so as to perform a cross-ecosystem management and control on the device to be shared through the target cloud.

After the cross-ecosystem sharing information is generated in the target application, it is transmitted to the application to be shared through cross-application means in which the application to be shared and the device to be shared belong to different ecosystems, and the application to be shared can access the target cloud of the target ecosystem corresponding to the device to be shared based on the cross-ecosystem sharing information without negotiation such that the application to be shared can perform a cross-ecosystem management and control on the device to be shared through the target cloud.

In one embodiment, the cross-ecosystem sharing information may comprise basic address information of the target cloud, device information of the device to be shared and access credentials; wherein the step that the application to be shared accesses the target cloud of the target ecosystem without negotiation based on the cross-ecosystem sharing information so as to perform the cross-ecosystem management and control on the device to be shared through the target cloud may further comprise: the application to be shared obtains an TSL model and pre-agreed path information, and constructs an access address according to the path information and the basic address information, constructs access parameters according to the device information, the access credentials and the TSL model according to a pre-agreed format, and, based on the access address and the access parameters, sends a target instruction to the target cloud, so that the target cloud manages and controls the device to be shared.

The TSL model abstracts the application to be shared into a data model composed of properties, services, and events, and the pre-agreed path information is the path information pre-agreed to access the target cloud. After the application to be shared combines the basic address information and the path information to form an access path, and constructs the access parameters according to a preset format based on the device information, the access credentials, and the TSL model, the application to be shared may send a target instruction to the target cloud based on the access address and access parameters, and the target instruction can enable the cloud to perform control operations, such as device information acquisition, device event subscription, device control, and refresh control authorization, on the device to be shared.

In one embodiment, the cross-ecosystem sharing information may comprise basic address information of the target cloud, device information of the device to be shared and access credentials; wherein the step that the application to be shared accesses the target cloud of the target ecosystem without negotiation based on the cross-ecosystem sharing information so as to perform the cross-ecosystem management and control on the device to be shared through the target cloud may further comprise: the application to be shared transmits the cross-ecosystem sharing information to the belonging cloud of the ecosystem to which the application to be shared belongs, wherein the belonging cloud obtains the TSL model and the pre-agreed path information, constructs an access address according to the path information and the basic address information, and constructs access parameters according to a pre-agreed format based on the device information, the access credentials and the TSL model, and the belonging cloud sends a target instruction to the target cloud based on the access address and the access parameters, so that the target cloud manages and controls the device to be shared.

The TSL model abstracts the application to be shared into a data model composed of properties, services, and events, and the pre-agreed path information is the path information pre-agreed to access the target cloud. The belonging cloud corresponding to the application to be shared combines the basic address information and the path information to form an access path, and constructs the access parameters according to the device information, the access credentials, and the TSL model according to a preset format, and then the application to be shared may send a target instruction to the target cloud based on the access address and access parameters through the respective belonging cloud, and the target instruction can enable the cloud to perform control operations, such as device information acquisition, device event subscription, device control, and refresh control authorization, on the device to be shared.

To facilitate the better implementation of the cross-ecosystem device management and control method provided by the embodiments of the present disclosure, the embodiments of the application also provide a cross-ecosystem device management and control device based on the cross-ecosystem device management and control method. The meanings of the terms therein are the same as those in the above-mentioned cross-ecosystem device management and control method, and the specific implementation details can be referred to the description in the method embodiments. FIG. 3 is a block diagram illustrating a cross-ecosystem device management and control device according to an embodiment of the present disclosure.

As shown in FIG. 3, the cross-ecosystem device management and control device 300 may comprise a generation module 310 and a sharing module 320.

The generation module 310 may be used to generate cross-ecosystem sharing information of the device to be shared based on a target application, and the device to be shared belongs to a target ecosystem; the sharing module 320 may be used to transmit the cross-ecosystem sharing information across applications to the application to be shared, wherein the application to be shared and the device to be shared belong to different ecosystems, wherein the application to be shared accesses the target cloud of the target ecosystem without negotiation based on the cross-ecosystem sharing information, so as to perform a cross-ecosystem management and control on the device to be shared through the target cloud.

In some embodiments of the present disclosure, the device may further comprise: a prompt content display unit which is configured to display an authorization prompt content for information sharing through the target application; and a response information receiving unit which is configured to receives response information of the authorization prompt content to determine whether to transmit the cross-ecosystem sharing information across applications based on the response information.

In some embodiments of the present disclosure, the cross-ecosystem sharing information may comprise basic address information of the target cloud, device information of the device to be shared and access credentials; wherein the step that the application to be shared accesses the target cloud of the target ecosystem without negotiation based on the cross-ecosystem sharing information so as to perform the cross-ecosystem management and control on the device to be shared through the target cloud may further comprise: the application to be shared obtains an TSL model and pre-agreed path information, and constructs an access address according to the path information and the basic address information, constructs access parameters according to a pre-agreed format based on the device information, the access credentials and the TSL model, and, based on the access address and the access parameters, sends a target instruction to the target cloud, so that the target cloud manages and controls the device to be shared.

In some embodiments of the present disclosure, the cross-ecosystem sharing information may comprise basic address information of the target cloud, device information of the device to be shared and access credentials; wherein the step that the application to be shared accesses the target cloud of the target ecosystem without negotiation based on the cross-ecosystem sharing information so as to perform the cross-ecosystem management and control on the device to be shared through the target cloud may further comprise: the application to be shared transmits the cross-ecosystem sharing information to the belonging cloud of the ecosystem to which the application to be shared belongs, wherein the belonging cloud obtains the TSL model and the pre-agreed path information, constructs an access address according to the path information and the basic address information, and constructs access parameters according to a pre-agreed format based on the device information, the access credentials and the TSL model, and the belonging cloud sends a target instruction to the target cloud based on the access address and the access parameters, so that the target cloud manages and controls the device to be shared.

In some embodiments of the present disclosure, the sharing module comprises a first sharing unit for: displaying an application list based on the first application; determining the application to be shared selected from the application list; and transmitting the cross-ecosystem sharing information to the application to be shared using a cross-application protocol through the first application.

In some embodiments of the present disclosure, the sharing module comprises a second sharing unit for: obtaining an information transmission content containing the cross-ecosystem sharing information based on the first application; and sending the information transmission content to a target terminal through the first application such that the target terminal opens the application to be shared according to a target protocol and transmits the information transmission content to the application to be shared.

In some embodiments of the present disclosure, the sharing module comprises a third sharing unit for: obtaining an information transmission content containing the cross-ecosystem sharing information based on the first application, and copying the information transmission content to a target location so that the application to be shared may obtain the information transmission content from the target location when a target object opens the application to be shared.

In this way, based on the cross-ecosystem device management and control device 300, the cross-ecosystem sharing information is transmitted across applications to the application to be shared, and the application to be shared accesses the target cloud of the target ecosystem based on the cross-ecosystem sharing information without negotiation, and the cross-ecosystem management and control of the device to be shared can be performed through the target cloud, thus achieving convenient and effective cross-ecosystem device management and control.

It should be noted that, although several modules or units of the device used for the execution of actions are mentioned in the detailed description above, this division is not mandatory. Indeed, according to the embodiments of the present disclosure, the features and functions of two or more modules or units described above may be embodied in a single module or unit. Conversely, the features and functions of a single module or unit described above may be further divided to be embodied by multiple modules or units.

In addition, the embodiments of the present disclosure also provide an electronic device, which can be a terminal or a server, as shown in FIG. 4, which shows a schematic diagram of the structure of the electronic device involved in the embodiment of the present disclosure.

The electronic device may include a processor 401 with one or more processing cores, a memory 402 with one or more computer-readable storage medium, a power supply 403, an input unit 404 and other components. It will be appreciated by those skilled in the art that the structure of the electronic device illustrated in FIG. 4 does not constitute a limitation of the electronic device, and may include more or fewer components than illustrated, or a combination of certain components, or a different arrangement of components.

The processor 401 is the control center of the electronic equipment, which utilizes various interfaces and lines to connect various parts of the entire computer equipment, and performs various functions and processing data of the computer equipment by running or executing software programs and/or modules stored in the memory 402, and calling the data stored in the memory 402, so as to carry out overall monitoring of the electronic equipment. Optionally, the processor 401 may include one or more processing cores; Preferably, the processor 401 can integrate an application processor and a modem processor, wherein the application processor mainly processes the operating system, user pages and applications, etc., and the modem processor mainly processes wireless communication. It is understandable that the aforementioned modem processor can also be left unintegrated into the processor 401.

The memory 402 can be used to store software programs and modules, and the processor 401 performs various functional applications and data processing by running software programs and modules stored in memory 402. The memory 402 may mainly include a storage program area and a storage data area, wherein the storage program area can store the operating system, at least one function required application (such as sound playback function, image playback function, etc.); The storage data area can store data created based on the use of computer equipment, etc. In addition, memory 402 may include high-speed random access memory and may include non-volatile memory, such as at least one disk storage device, flash memory device, or other volatile solid-state memory device. Correspondingly, memory 402 may also include a memory controller to provide access from processor 401 to memory 402.

The electronic equipment also comprises a power supply 403 that supplies power to each component, and preferably, the power supply 403 can be logically connected with the processor 401 through a power management system, so that functions such as managing charging, discharging, and power consumption management are realized through the power management system. The power supply 403 can also include any component such as one or more DC or AC power sources, recharging systems, power fault detection circuits, power converters or inverters, and power status indicators.

The electronic device may also include an input unit 404 that can be used to receive input numeric or character information and to generate keyboard, mouse, joystick, optical or trackball signal input related to user settings and function control. Although not shown, the electronic device may also include a display unit and the like, which will not be described herein. Specifically, in this embodiment, the processor 401 in the electronic device will load executable files corresponding to the processes of one or more computer programs into the memory 402 in accordance with the following instructions, and the processor 401 will run the computer programs stored in the memory 402, so as to realize the various functions in the foregoing embodiments of the present disclosure, e.g., the processor 401 may execute the above-described cross-ecosystem device management and control method.

According to an embodiment of the present disclosure, a cross-ecosystem device management and control method comprises: generating cross-ecosystem sharing information of the device to be shared based on a target application, wherein the device to be shared belongs to a target ecosystem; transmitting the cross-ecosystem sharing information across applications to the application to be shared, wherein the application to be shared and the device to be shared belong to different ecosystems, wherein the application to be shared accesses a target cloud of the target ecosystem without negotiation based on the cross-ecosystem sharing information, so as to perform a cross-ecosystem management and control on the device to be shared through the target cloud.

In some embodiments of the present disclosure, prior to the transmitting of the cross-ecosystem sharing information across applications to the application to be shared, the processor 401 may be perform: displaying an authorization prompt content for information sharing through the target application; and receiving response information of the authorization prompt content to determine whether to transmit the cross-ecosystem sharing information across applications based on the response information.

In some embodiments of the present disclosure, the cross-ecosystem sharing information comprises basic address information of the target cloud, device information of the device to be shared and access credentials; the step that the application to be shared accesses the target cloud of the target ecosystem without negotiation based on the cross-ecosystem sharing information so as to perform the cross-ecosystem management and control on the device to be shared through the target cloud comprising: obtaining, by the application to be shared, an TSL model and pre-agreed path information, and constructing an access address according to the path information and the basic address information, and constructing access parameters according to a pre-agreed format based on the device information, the access credentials and the TSL model, and based on the access address and the access parameters, sending a target instruction to the target cloud, so that the target cloud manages and controls the device to be shared.

In some embodiments of the present disclosure, the cross-ecosystem sharing information comprises basic address information of the target cloud, device information of the device to be shared and access credentials; the step that the application to be shared accesses the target cloud of the target ecosystem without negotiation based on the cross-ecosystem sharing information so as to perform the cross-ecosystem management and control on the device to be shared through the target cloud comprising: the application to be shared transmitting the cross-ecosystem sharing information to the belonging cloud of the ecosystem to which the application to be shared belongs, wherein the belonging cloud obtains the TSL model and the pre-agreed path information, constructs an access address according to the path information and the basic address information, and constructs access parameters according to a pre-agreed format based on the device information, the access credentials and the TSL model, and the belonging cloud sends a target instruction to the target cloud based on the access address and the access parameters, so that the target cloud manages and controls the device to be shared.

In some embodiments of the present disclosure, the step of transmitting the cross-ecosystem sharing information across applications to the application to be shared comprises: displaying an application list based on the target application; determining the application to be shared selected from the application list; and transmitting the cross-ecosystem sharing information to the application to be shared using a cross-application protocol through the target application.

In some embodiments of the present disclosure, the step of transmitting the cross-ecosystem sharing information across applications to the application to be shared comprises: obtaining an information transmission content containing the cross-ecosystem sharing information based on the target application; and sending the information transmission content to a target terminal through the target application, so that the target terminal opens the application to be shared based on a target protocol and transmits the information transmission content to the application to be shared.

In some embodiments of the present disclosure, the step of transmitting the cross-ecosystem sharing information across applications to the application to be shared comprises: obtaining an information transmission content containing the cross-ecosystem sharing information based on the target application, and copying the information transmission content to a target location so that the application to be shared obtains the information transmission content from the target position when a target object opens the application to be shared.

Those skilled in the art will appreciate that all or part of the steps in the various methods of the above embodiments may be completed by a computer program or by controlling the relevant hardware through a computer program, which may be stored in a computer-readable storage medium and loaded and executed by a processor.

For this purpose, the embodiment of the present disclosure also provides a storage medium in which a computer program is stored, the computer program being capable of being loaded by a processor to perform steps in any of the methods provided in the embodiments of the present disclosure.

The storage medium may include: Read Only Memory (ROM), Random Access Memory (RAM), disks or optical discs, etc.

Because the computer program stored in the storage medium can perform the steps in any of the methods provided in the embodiments of the present disclosure, the beneficial effects that can be achieved by the methods provided in the embodiments of the present disclosure can be realized, see the previous embodiments for details, and will not be repeated herein.

A person skilled in the art will be apt to think of other embodiments of the present disclosure after considering the embodiments disclosed herein in the specification and practice. The application is intended to cover any variants, uses, or adaptations of the present disclosure, which follow the general principles of the present disclosure and include common knowledge or customary technical means in the art not disclosed in the present disclosure.

It should be understood that the present disclosure is not limited to the embodiments that have been described above and illustrated in the accompanying drawings, but may be subject to various modifications and alterations without departing from the scope thereof.

1. A cross-ecosystem device management and control methods, comprising:
generating cross-ecosystem sharing information of the device to be shared based on a target application, the device to be shared belonging to a target ecosystem;
transmitting the cross-ecosystem sharing information across applications to an application to be shared, the application to be shared and the device to be shared belonging to different ecosystems;
wherein the application to be shared accesses a target cloud of the target ecosystem without negotiation based on the cross-ecosystem sharing information, so as to perform a cross-ecosystem management and control on the device to be shared through the target cloud.

2. The method of claim 1, wherein prior to the transmitting of the cross-ecosystem sharing information across applications to the application to be shared, the method further comprises:
displaying an authorization prompt content for information sharing through the target application; and
receiving response information of the authorization prompt content to determine whether to transmit the cross-ecosystem sharing information across applications based on the response information.

3. The method of claim 1, wherein the cross-ecosystem sharing information comprises basic address information of the target cloud, device information of the device to be shared and access credentials;
the step that the application to be shared accesses the target cloud of the target ecosystem without negotiation based on the cross-ecosystem sharing information so as to perform the cross-ecosystem management and control on the device to be shared through the target cloud comprising:
obtaining, by the application to be shared, an TSL model and pre-agreed path information, and constructing an access address according to the path information and the basic address information, and constructing access parameters according to a pre-agreed format based on the device information, the access credentials and the TSL model; and
based on the access address and the access parameters, sending a target instruction to the target cloud, so that the target cloud manages and controls the device to be shared.

4. The method of claim 1, wherein the cross-ecosystem sharing information comprises basic address information of the target cloud, device information of the device to be shared and access credentials;
the step that the application to be shared accesses the target cloud of the target ecosystem without negotiation based on the cross-ecosystem sharing information so as to perform the cross-ecosystem management and control on the device to be shared through the target cloud comprising:
the application to be shared transmitting the cross-ecosystem sharing information to the belonging cloud of the ecosystem to which the application to be shared belongs,
wherein the belonging cloud obtains the TSL model and the pre-agreed path information, constructs an access address according to the path information and the basic address information, and constructs access parameters according to a pre-agreed format based on the device information, the access credentials and the TSL model,
and the belonging cloud sends a target instruction to the target cloud based on the access address and the access parameters, so that the target cloud manages and controls the device to be shared.

5. The method of claim 1, wherein the step of transmitting the cross-ecosystem sharing information across applications to the application to be shared comprises:
displaying an application list based on the target application;
determining the application to be shared selected from the application list; and
transmitting the cross-ecosystem sharing information to the application to be shared using a cross-application protocol through the target application.

6. The method of claim 1, wherein the step of transmitting the cross-ecosystem sharing information across applications to the application to be shared comprises:
obtaining an information transmission content containing the cross-ecosystem sharing information based on the target application; and
sending the information transmission content to a target terminal through the target application, so that the target terminal opens the application to be shared based on a target protocol and transmits the information transmission content to the application to be shared.

7. The method of claim 1, wherein the step of transmitting the cross-ecosystem sharing information across applications to the application to be shared comprises:
obtaining an information transmission content containing the cross-ecosystem sharing information based on the target application, and copying the information transmission content to a target location so that the application to be shared obtains the information transmission content from the target position when a target object opens the application to be shared.

8. The method of claim 5, wherein the application list lists all applications in the system that that meet a same criterion for selection by the user, and the manner in which the applications are listed in the application list comprises at least one of the following methods:
listing applications that declare a same URL scheme;
listing applications that declare they can open a same type of file;
listing applications that declare a sharing control that contains a same keyword.

9. The method of claim 5, wherein the step of transmitting the cross-ecosystem sharing information to the application to be shared using the cross-application protocol through the target application comprises:
converting the cross-ecosystem sharing information in the target application into a message accepted by the application to be shared through the cross-application protocol and transmitting the message accepted by the application to be shared to the application to be shared.

10. The method of claim 2, wherein the determination of whether to transmit the cross-ecosystem sharing information across applications based on the response information comprises:
determining to transmit the cross-ecosystem sharing information across applications if the response information is agreed; and
determining that the cross-ecosystem sharing information can't be transmitted across applications if the response information is disagreed.

11. The method of claim 2, wherein, after the displaying of the authorization prompt content for information sharing through the target application, the method further comprises: generating the response information in response to that the user clicks an authorization response control in a display interface.

12-18. (canceled)

19. A non-transitory storage medium storing a computer program executable by a processor to perform the method as claimed in claim 1.

20. An electronic device, comprising: a memory storing a computer program; and a processor reading the computer program stored in the memory to perform operations comprising:
generating cross-ecosystem sharing information of the device to be shared based on a target application, the device to be shared belonging to a target ecosystem;
transmitting the cross-ecosystem sharing information across applications to an application to be shared, the application to be shared and the device to be shared belonging to different ecosystems;
wherein the application to be shared accesses a target cloud of the target ecosystem without negotiation based on the cross-ecosystem sharing information, so as to perform a cross-ecosystem management and control on the device to be shared through the target cloud.

21. The electronic device of claim 20, wherein prior to the transmitting of the cross-ecosystem sharing information across applications to the application to be shared, the method further comprises:
displaying an authorization prompt content for information sharing through the target application; and
receiving response information of the authorization prompt content to determine whether to transmit the cross-ecosystem sharing information across applications based on the response information.

22. The electronic device of claim 20, wherein the cross-ecosystem sharing information comprises basic address information of the target cloud, device information of the device to be shared and access credentials;
the operation that the application to be shared accesses the target cloud of the target ecosystem without negotiation based on the cross-ecosystem sharing information so as to perform the cross-ecosystem management and control on the device to be shared through the target cloud comprising:
obtaining, by the application to be shared, an TSL model and pre-agreed path information, and constructing an access address according to the path information and the basic address information, and constructing access parameters according to a pre-agreed format based on the device information, the access credentials and the TSL model; and
based on the access address and the access parameters, sending a target instruction to the target cloud, so that the target cloud manages and controls the device to be shared.

23. The electronic device of claim 20, wherein the cross-ecosystem sharing information comprises basic address information of the target cloud, device information of the device to be shared and access credentials;
the operation that the application to be shared accesses the target cloud of the target ecosystem without negotiation based on the cross-ecosystem sharing information so as to perform the cross-ecosystem management and control on the device to be shared through the target cloud comprising:
the application to be shared transmitting the cross-ecosystem sharing information to the belonging cloud of the ecosystem to which the application to be shared belongs,
wherein the belonging cloud obtains the TSL model and the pre-agreed path information, constructs an access address according to the path information and the basic address information, and constructs access parameters according to a pre-agreed format based on the device information, the access credentials and the TSL model,
and the belonging cloud sends a target instruction to the target cloud based on the access address and the access parameters, so that the target cloud manages and controls the device to be shared.

24. The electronic device of claim 20, wherein the operation of transmitting the cross-ecosystem sharing information across applications to the application to be shared comprises:
displaying an application list based on the target application;
determining the application to be shared selected from the application list; and
transmitting the cross-ecosystem sharing information to the application to be shared using a cross-application protocol through the target application.

25. The electronic device of claim 20, wherein the operation of transmitting the cross-ecosystem sharing information across applications to the application to be shared comprises:
obtaining an information transmission content containing the cross-ecosystem sharing information based on the target application; and
sending the information transmission content to a target terminal through the target application, so that the target terminal opens the application to be shared based on a target protocol and transmits the information transmission content to the application to be shared.

26. The electronic device of claim 20, wherein the operation of transmitting the cross-ecosystem sharing information across applications to the application to be shared comprises:
obtaining an information transmission content containing the cross-ecosystem sharing information based on the target application, and copying the information transmission content to a target location so that the application to be shared obtains the information transmission content from the target position when a target object opens the application to be shared.

27. The electronic device of claim 24, wherein the application list lists all applications in the system that that meet a same criterion for selection by the user, and the manner in which the applications are listed in the application list comprises at least one of the following methods:
listing applications that declare a same URL scheme;
listing applications that declare they can open a same type of file;
listing applications that declare a sharing control that contains a same keyword.
